(19) United States
(12) Patent Application Publication
(10) Pub. No.: US 2006/0158577 A1
(43) Pub. Date: Jul. 20, 2006

(54) Thin film transistor array panel for liquid crystal display and liquid crystal display

(75) Inventors: Teruo Katakura, Gyeonggi-do (KR); Dan-Sik Yoo, Gyeonggi-do (KR)

Correspondence Address: David W. Heid;MacPHERSON KWOK CHEN & HEID LLP, Suite 226, 1762 Technology Drive, San Jose, CA, 95110, US

(73) Assignee: SAMSUNG ELECTRONICS CO., LTD., Suwon-si (KR)

(21) Appl. No.: 11/280,553

(22) Filed: Nov. 15, 2005

(30) Foreign Application Priority Data
Jan. 17, 2005 (KR) 10-2005-0004268

(51) Int. Cl. G02F 1/136

(52) U.S. Cl. 349/44

(57) ABSTRACT

A thin film transistor array panel includes a substrate including a display area and a peripheral area disposed at the outside of the display area, shield members formed in the peripheral area, gate lines formed in the display area and the peripheral area, a first insulating layer formed on the shield members and the gate lines, semiconductor layers formed on the first insulating layer, and data lines formed on the semiconductor layers and drain electrodes separated from the data lines.

### CROSS-REFERENCE TO RELATED APPLICATIONS

This application claims priority from Korean Patent Application No. 10-2005-0004268 filed Jan. 17, 2005, the contents of which are herein incorporated by reference in their entirety.

### BACKGROUND OF THE INVENTION

(a) Field of the Invention

The present invention relates to a liquid crystal display and a thin film transistor array panel for a liquid crystal display.

(b) Description of Related Art

Generally, a liquid crystal display (LCD) includes a liquid crystal (LC) panel assembly including two panels provided with pixel electrodes and common electrodes, and an LC layer with dielectric anisotropy interposed between the panels. The pixel electrodes are arranged in a matrix and are connected to switching elements such as thin film transistors (TFT) that sequentially apply data voltages to each row of the matrix. The common electrodes cover the entire surface of the upper panel and are supplied with a common voltage Vcom. A pixel electrode, a common electrode, and the LC layer can be electrically characterized as an LC capacitor, and the LC capacitor connected to a switching element forms the basic unit of a pixel.

The LCD displays images by applying an electric field to a liquid crystal layer situated between the two panels and regulating the strength of the electric field to adjust the transmittance of light passing through the liquid crystal layer.

The light for an LCD is provided by lamps on the LCD or natural light. When employing the lamps, the brightness of the screen is usually adjusted by regulating the ratio of on and off durations of the lamps or regulating the current flowing in the lamps.

The lamps for the LCD usually include fluorescent lamps such as a cold cathode fluorescent lamp (CCFL) or an external electrode fluorescent lamp (EEFL) driven by an inverter. The inverter converts DC voltage into AC voltage and applies the AC voltage to the lamps to be turned on. The inverter applies the AC voltages to the lamps at a certain frequency, for example, at a frequency of 3 to 4 times per frame, to control the on and off of the lamps, i.e., the backlight. The inverter also adjusts the luminance of the lamps according to a luminance control signal to control the luminance of the LCD. In addition, the inverter feedback controls the voltages applied to the lamps based on the currents of the lamps.

A problem in displays arises wherein repeatedly turning the backlight on and off affects the gate driving integrated circuits (ICs) or data driving ICs connected to gate pads or data pads located on the backlight, causing an undesirable “waterfall” effect. This effect consists of a regular flow of stripes in the displayed image. To prevent the waterfall effect, a chassis member can be interposed between the backlight and the panel or an insulating tape and a shield member can be provided. However, adding a chassis or insulating tape adds a process step and increases manufacturing cost.

### SUMMARY OF THE INVENTION

The present invention is directed to solving such conventional problems.

A liquid crystal display including a thin film transistor array panel provided with a display area and a peripheral area is provided, wherein the thin film transistor array panel includes a substrate, conductive wires formed on the display area and the peripheral area, shield members insulated from the conductive wires and formed in the same layer as the conductive wires on the peripheral area, an insulating layer formed on the conductive wires and the shield members and having contact holes exposing a portion of the conductive wires in the peripheral area, and contact pads formed on the insulating layer to overlap the shield members and electrically connected to the conductive wires in the peripheral area via the contact holes of the insulating layer.

The liquid crystal display includes a driving chip or driving circuit disposed on the contact pads on the shield member electrically connected to the contact pads, and a light source disposed at the back side of the thin film transistor array panel to provide light thereto, wherein the light source overlaps at least a portion of the shield members.

The conductive wires may be gate lines transmitting gate signals or data lines transmitting data voltages. The contact pads may include depressions for accommodating the driving chip or driving circuit, and they may be transparent electrodes.

A thin film transistor array panel is provided, which includes a substrate including a display area and a peripheral area disposed at the outside of the display area, shield members formed in the peripheral area, gate lines formed in the display area and the peripheral area, a first insulating layer formed on the shield members and the gate lines, semiconductor layers formed on the first insulating layer, and data lines formed on the semiconductor layers and drain electrodes separated from the data lines.

The thin film transistor array panel may further include a second insulating layer formed on the data lines and the drain electrodes, and pixel electrodes formed on the second insulating layer and connected to the drain electrodes. The second insulating layer may have auxiliary holes for contact with external devices, and the first and the second insulating layers have contact holes exposing the gate lines.

The thin film transistor array panel may further include connections formed on the auxiliary holes and the peripheries thereof, and connected to the gate lines via the contact holes.

The shield members may be connected to a ground voltage or other voltage to provide a shielding effect.

A liquid crystal display is provided, which includes a thin film transistor array panel including a display area provided with most of a plurality of pixels and display signal lines and a peripheral area disposed at the outside of the display area, and a light source unit disposed under the peripheral area. The display signal lines include first and second signal lines, and shield members are formed in a layer identical to the first signal lines in the peripheral area.

The thin film transistor array panel may include semiconductor layers formed on the first insulating layer, second signal lines formed on the semiconductor layers and output electrodes separated from the second signal lines, a second insulating layer formed on the second signal lines and the output electrodes, and pixel electrodes formed on the second insulating layer and connected to the output electrodes. The second insulating layer may have auxiliary holes for contact with external devices, and the first and second insulating layers have contact holes exposing the first signal lines.

The liquid crystal display may further include connections formed on the auxiliary holes and peripheries thereof, connected to the first signal lines via the contact holes.

The first signal lines may be gate lines transmitting gate signals, and the second signal lines may be data lines transmitting data signals. The shield members may be connected to a ground voltage, and the light source unit may include a cold cathode fluorescent lamp.

The liquid crystal display may further include a plurality of gate driving integrated circuits and data driving integrated circuits applying gate signals and data voltages to the first and the second signal lines, respectively, wherein the gate and the data driving integrated circuits are mounted on the shield members. The gate and the data driving integrated circuits may be mounted as a COG (chip on glass) type in the peripheral area.

### BRIEF DESCRIPTION OF THE DRAWINGS

The present invention will become more apparent by describing preferred embodiments thereof in detail with reference to the accompanying drawings, in which:

FIG. 1 is a block diagram of an LCD according to an exemplary embodiment of the present invention;

FIG. 2 illustrates a structure and an equivalent circuit diagram of a pixel of an LCD according to an exemplary embodiment of the present invention;

FIG. 3 is a schematic view of an LCD according to an exemplary embodiment of the present invention;

FIG. 4 is a layout view of a thin film transistor array panel for an LCD according to an embodiment of the present invention; and

FIG. 5 is a sectional view of the thin film transistor array panel shown in FIG. 4 taken along the line 5-5′.

### DETAILED DESCRIPTION OF EMBODIMENTS

The present invention is described in detail hereinafter with reference to the accompanying drawings, in which preferred embodiments of the invention are shown. This invention may, however, be embodied in many different forms and should not be construed as limited to the embodiments set forth herein.

In the drawings, the thickness of the layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

An LCD according to embodiments of the present invention is described with reference to the drawings.

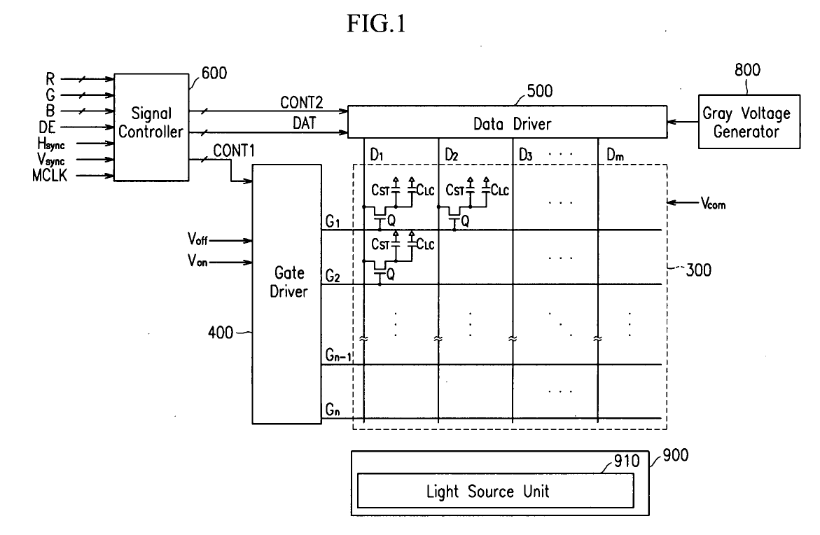

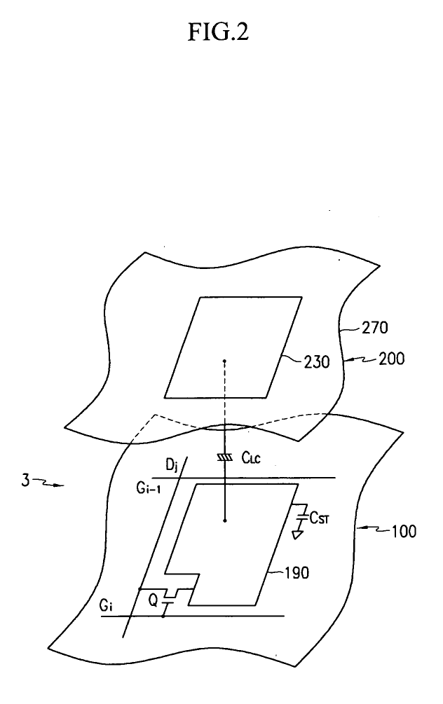

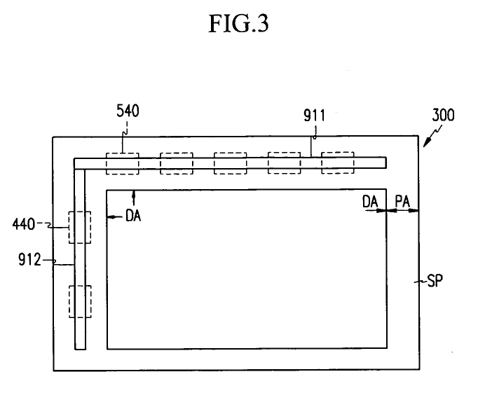

FIG. 1 is a block diagram of an LCD according to an embodiment of the present invention. FIG. 2 illustrates a structure and an equivalent circuit diagram of a pixel of an LCD according to an embodiment of the present invention. FIG. 3 is a schematic view of an LCD according to an embodiment of the present invention.

Referring to FIG. 1, an LCD according to an embodiment of the present invention includes an LC panel assembly 300, a gate driver 400 and a data driver 500 connected thereto, a gray voltage generator 800 connected to the data driver 500, a backlight unit 900 providing light for the LC assembly 300, and a signal controller 600 controlling the above-described elements.

The LC panel assembly 300, in a structural view shown in FIG. 2, includes a lower panel 100, an upper panel 200, and a liquid crystal (“LC”) layer 3 interposed therebetween, and a plurality of display signal lines G1-Gn and D1-Dm and a plurality of pixels that are connected thereto and arranged substantially in a matrix as shown in FIGS. 1 and 2.

The display signal lines G₁-Gₙ, and D₁-Dₘ are provided on the lower panel 100 and include a plurality of gate lines G₁-Gₙ transmitting gate signals (called scanning signals) and a plurality of data lines D₁-Dₘ transmitting data signals. The gate lines G₁-Gₙ extend substantially in a row direction and they are substantially parallel to each other, while the data lines D₁-Dₘ extend substantially in a column direction and they are substantially parallel to each other.

Each pixel includes a switching element Q, which can be a thin-film transistor (TFT), connected to the display signal lines G₁-Gₙ and D₁-Dₘ, and an LC capacitor C_{LC} and a storage capacitor C_{ST} that are connected to the switching element Q. The storage capacitor C_{ST} may be omitted if it is unnecessary.

The switching element Q is provided on the lower panel 100. A TFT-type switching element can have three terminals: a control terminal connected to one of the gate lines G1-Gn; an input terminal connected to one of the data lines D₁-Dₘ; and an output terminal connected to the LC capacitor C_{LC} and the storage capacitor C_{ST}.

The LC capacitor C_{LC} includes a pixel electrode 190 provided on the lower panel 100, a common electrode 270 provide on the upper panel 200, and the LC layer 3 acting as a dielectric between the electrodes 190 and 270. The pixel electrode 190 is connected to the switching element Q. Common electrodes 270 cover the entire surface of the upper panel 100 and is supplied with a common voltage Vcom. Alternatively, both the pixel electrode 190 and the common electrode 270, which have shapes of bars or stripes, may be provided on the lower panel 100, in a so-called “in plane switching” scheme.

The storage capacitor C_{ST} is an auxiliary capacitor for the LC capacitor C_{LC}. The storage capacitor C_{ST} includes the pixel electrode 190 and a separate signal line (not shown), which is provided on the lower panel 100, which overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel uniquely represents one of three primary colors such as red, green, and blue colors (spatial division) or sequentially represents the three primary colors in time (temporal division), thereby obtaining a desired color. FIG. 2 shows an example of spatial division in which each pixel includes a color filter 230 representing one of the three primary colors in an area of the upper panel 200 facing the pixel electrode 190. Alternatively, the color filter 230 is provided on or under the pixel electrode 190 on the lower panel 100.

The backlight unit 900 includes an inverter (not shown), and a light source unit 910. The light source unit 910, which includes at least one lamp, is disposed at the backside of the LC assembly 300. A CCFL or an EEFL is used as the lamp, or a light emitting diode (LED) may be used.

A pair of polarizers (not shown) for polarizing light from the light source unit is attached on the outer surfaces of the lower and upper panels 100 and 200 of the panel assembly 300.

Referring back to FIG. 1, a Gray voltage generator 800 generates one set or two sets of gray voltages related to the transmittance of the pixels. When two sets of the gray voltages are generated, the gray voltages in one set have a positive polarity with respect to the common voltage Vcom, while the gray voltages in the other set have a negative polarity with respect to the common voltage Vcom.

The gate driver 400 is connected to the gate lines G₁-Gₙ of the panel assembly 300 and synthesizes the gate-on voltage Von and the gate-off voltage Voff from an external device to generate gate signals for application to the gate lines G₁-Gₙ.

The data driver 500 is connected to the data lines D₁-Dₘ of the panel assembly 300 and applies data voltages, which are selected from the gray voltages supplied from the gray voltage generator 800, to the data lines D₁-Dₘ.

The drivers 400 and 500 may include at least one integrated circuit (IC) chip mounted on the panel assembly 300 or on a flexible printed circuit film (FPC) as a tape carrier package (TCP) type, which are attached to the LC panel assembly 300. Alternately, the drivers 400 and 500 may be integrated into the panel assembly 300 along with the display signal lines G₁-Gₙ and D₁-Dₘ and the TFT switching elements Q.

The signal controller 600 controls the gate driver 400 and the data driver 500.

Now, the operation of the display device will be described in detail referring to FIG. 1.

The signal controller 600 is supplied with image signals R, G, and B and input control signals controlling the display of the image signals R, G, and B from an external graphic controller (not shown). The input control signals include, for example, a vertical synchronization signal Vsync, a horizontal synchronization signal Hsync, a main clock MCLK, and a data enable signal DE. After generating gate control signals CONT1 and data control signals CONT2 and processing the image signals R, G, and B to be suitable for the operation of the panel assembly 300 in response to the input control signals, the signal controller 600 provides the gate control signals CONT1 to the gate driver 400, and the processed image signals DAT and the data control signals CONT2 to the data driver 500.

The gate control signals CONT1 include a vertical synchronization start signal STV for informing the gate driver of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply the appropriate data voltages to the data lines D₁-Dₘ, and a data clock signal HCLK. The data control signals CONT2 may further include an inversion control signal RVS for reversing the polarity of the data voltages (with respect to the common voltage Vcom).

The data driver 500 receives the processed image signals DAT for a pixel row from the signal controller 600 and converts them into the analogue data voltages selected from the gray voltages supplied from the gray voltage generator 800 in response to the data control signals CONT2 from the signal controller 600.

In response to the gate control signals CONT1 from the signal controller 600, the gate driver 400 applies the gate-on voltage Von to the gate lines G₁-Gₙ, thereby turning on the switching elements Q connected to the gate lines G₁-Gₙ.

The data driver 500 applies the data voltages to corresponding data lines D₁-Dₘ for a turn-on time of the switching elements Q (which is called “one horizontal period” or “1H” and equals one period of the horizontal synchronization signal Hsync, the data enable signal DE, and the gate clock signal CPV). The data voltages in turn are supplied to corresponding pixels via the turned-on switching elements Q.

The difference between the data voltage and the common voltage Vcom applied to a pixel is expressed as a charged voltage of the LC capacitor C_{LC}, i.e., a pixel voltage. The liquid crystal molecules have orientations depending on a magnitude of the pixel voltage, and the orientations determine a polarization of light passing through the LC capacitor C_{LC}. The polarizers convert light polarization into light transmittance.

By repeating the above-described procedure, all gate lines G₁-Gₙ are sequentially supplied with the gate-on voltage Von during a frame, thereby applying the data voltages to all pixels. When a next frame starts after finishing one frame, the inversion control signal RVS applied to the data driver 500 is controlled such that the polarity of the data voltages is reversed (“frame inversion”). The inversion control signal RVS may be controlled such that the polarity of the data voltages flowing in a data line in one frame is reversed (e.g. “row inversion”, “dot inversion”), or the polarity of the data voltages in one packet is reversed (e.g. “column inversion”, “dot inversion”).

A thin film array panel for an LCD according to an exemplary embodiment of the present invention will now be described in detail with reference to FIGS. 3, 4 and 5.

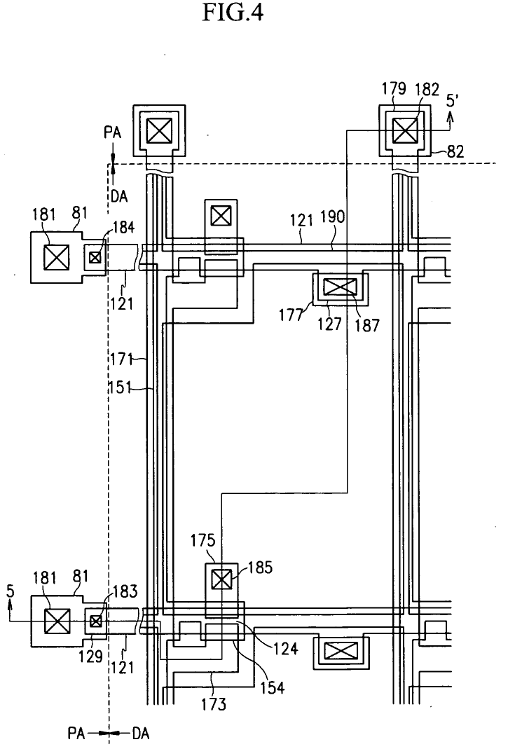

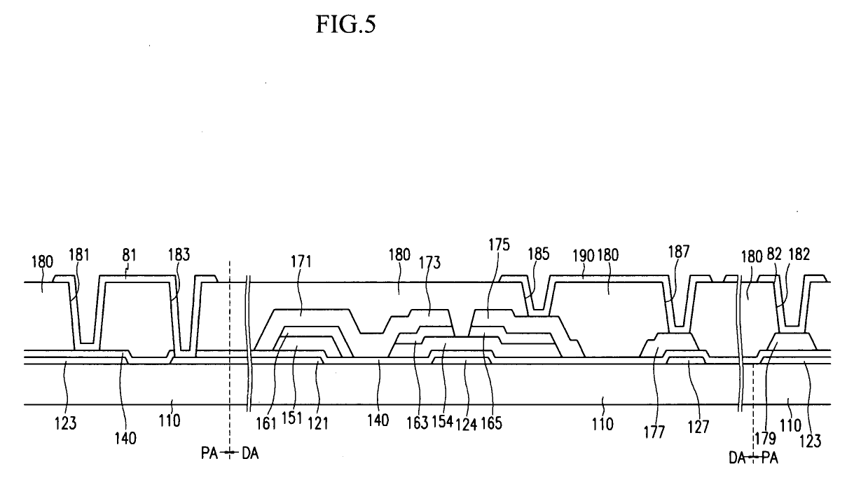

FIG. 3 shows the LC assembly 300 of FIG. 1 in detail. FIG. 4 is a layout view of a thin film transistor array panel for an LCD according to an embodiment of the present invention, and FIG. 5 is a sectional view of the thin film transistor array panel shown in FIG. 4 taken along the line 5-5′.

Referring to FIG. 3, the LC assembly 300 includes a display area DA provided with most of the pixels and the display signal lines G₁-Gₙ and D₁-Dₘ, and a peripheral area PA. The peripheral area PA contains multiple layers: one layer comprising lamps 911 and 912 of the light source unit 910, an intermediate layer occupied by a shield SP, and another layer comprising driving circuits 440 and 540. Thus the shield SP is interposed between the driving circuits and the lamps to provide a shielding effect between the two components. The details of this are further described below referring to FIGS. 4 and 5.

In FIG. 4, a plurality of gate lines 121 extend substantially in a transverse direction and is formed in the display area DA and in a portion of the peripheral area PA. Each gate line 121 includes a plurality of expansions 127 protruding perpendicularly from the gate lines. As seen in the cross-sectional view of FIG. 5, the gate lines 121 and the shield members 123 are both formed on an insulating substrate 110. Shield members 123 comprising the shield SP are insulated from the gate lines 121 by the insulating substrate 110 and the insulating layer 140, which is preferably made of silicon nitride (SiNx). Shield members 123 are electrically connected to a voltage such as a ground voltage provided by, for example, a data voltage flexible printed circuit film (FPC) or a gate FPC (FPC's and connections thereto not shown in FIG. 4) disposed outside the LC assembly 300 of FIG. 3.

Signal lines from the driver circuits 440 and 540 in FIG. 3 are electrically connected to contact pads 181 in FIG. 4, which overlap, but do not touch, the shield members 123. The shield members 123 are separated from the contact pads 181 by the insulating layer 140. The contact pads 181 are then electrically connected to the gate lines 121 via contact holes 183 that penetrate the passivation layer 180 and expose the underlying gate lines 121. Note that, without limitation to the case illustrated in FIG. 4, contact pads 181 may also be connected to data and other signal lines in the manner described above.

The shield members 123 are preferably connected to a ground voltage in a predetermined pattern. For example, contact holes and contact assistants exposing the shield members 123 are formed in the passivation layer 180 such that the shield members 123 are connected to a data flexible printed circuit film (FPC) (connection not shown) or a gate FPC (connection not shown) disposed at the outside of the LC assembly 300. Thus, the shield members 123 are connected to a ground voltage or some other constant voltage provided on the FPC via signal lines, thereby obtaining a robust shielding effect.

As mentioned, the shield members 123 are interposed between upper areas in which the driving ICs 440 and 540 in FIG. 3 are disposed and lower areas in which the lamps 911 and 912 are disposed, to prevent the turn-on frequencies of the lamps 911 and 912 from affecting the signal driver lines. This avoids a “waterfall” effect wherein a regular flow of stripes appears on the display. Additionally, the shield members 123 are formed by only a simple modification of a mask in the manufacturing process of the thin film transistor array panel, thereby decreasing manufacturing cost relative to providing a chassis member or insulating tape. Note that the shield members 123 may also be formed on areas in which the lamps 911 and 912 are not present.

The gate lines 121 and the shield members 123 include conductive layers preferably made of a low resistivity metal including an Al-containing metal such as Al and an Al alloy, an Ag containing metal such as Ag and an Ag alloy, or a Cu-containing metal such as Cu and an Cu alloy. However, the gate lines 121 may have a multi-layered structure including two films having different physical characteristics, i.e., a lower film and an upper film. The upper film is preferably made of a low resistivity metal including an Al-containing metal such as Al and an Al alloy, an Ag-containing metal such as Ag and an Ag alloy, or a Cu-containing metal such as Cu and a Cu alloy for reducing signal delay or voltage drop in the gate lines 121. On the other hand, the lower film is preferably made of a material such as Cr, Mo, a Mo alloy, Ta, or Ti, which has good physical, chemical, and electrical contact characteristics with other materials such as indium tin oxide (ITO) or indium zinc oxide (IZO). A good exemplary combination of the lower film material and the upper film material is Cr and an Al—Nd alloy.

In addition, the lateral sides of the gate lines 121 and the shield members 123 are inclined relative to a surface of the substrate 110, and the inclination angle thereof ranges about 30-80 degrees.

A gate insulating layer 140 preferably made of silicon nitride (SiNx) is formed on the gate lines 121.

The other layers of the display panel as shown in FIG. 5 are described below in detail. A plurality of semiconductor stripes 151 preferably made of hydrogenated amorphous silicon (abbreviated to “a-Si”) are formed on the gate insulating layer 140. Each semiconductor stripe 151 extends substantially in a longitudinal direction and has a plurality of projections 154 branched out toward the gate electrodes 124. The width of each semiconductor stripe 151 becomes large near the gate lines 121 such that the semiconductor stripe 151 covers large areas of the gate lines 121.

A plurality of ohmic contact stripes and islands 161 and 165 preferably made of silicide or n+ hydrogenated a-Si heavily doped with an n-type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are tapered, and the inclination angles thereof are preferably in a range between about 30-80 degrees.

A plurality of data lines 171, a plurality of drain electrodes 175, and a plurality of storage capacitor conductors 177 are formed on the ohmic contacts 161 and 165 and the gate insulating layer 140.

The data lines 171 for transmitting data voltages extend substantially in the longitudinal direction and intersect the gate lines 121. A plurality of branches of each data line 171, which project toward the drain electrodes 175, form a plurality of source electrodes 173. Each pair of the source electrodes 173 and the drain electrodes 175 are separated from each other and opposite each other with respect to a gate electrode 124. A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The storage capacitor conductors 177 overlap the expansions 127 of the gate lines 121, and an end portion 179 of each data line 171 has a large area for contact with another layer or an external device.

The data lines 171 also include conductive layers preferably made of Cr which have good physical, chemical, and electrical contact characteristics with other materials such as ITO or IZO. However, the data lines 171 may have a multilayered structure including a low-resistivity film (not shown) and a good-contact film (not shown). Examples of the multi-layered structure include a double-layered structure having a lower Cr film and an upper Al (alloy) film, a double-layered structure having a lower Mo (alloy) film and an upper Al (alloy) film, and a triple-layered structure having a lower Mo film, an intermediate Al film, and an upper Mo film.

The data lines 171 also have inclined lateral sides, and the inclination angles thereof range about 30-80 degrees.

The ohmic contacts 161 and 165 are interposed only between the underlying semiconductor stripes 151 and the overlying data lines 171 and the overlying drain electrodes 175 thereon, and reduce the contact resistance therebetween. The semiconductor stripes 151 include a plurality of exposed portions, which are not covered with the data lines 171 and the drain electrodes 175, such as portions located between the source electrodes 173 and the drain electrodes 175.

A passivation layer 180 is formed on the data lines 171, the drain electrodes 175, the storage conductors 177, and the exposed portions of the semiconductor stripes 151. The passivation layer 180 is preferably made of a photosensitive organic material having a good flatness characteristic, a low dielectric insulating material such as a-Si:C:O and a-Si:O:F formed by plasma enhanced chemical vapor deposition (PECVD), or an inorganic material such as silicon nitride. Alternatively, the passivation layer 180 includes a double-layered structure having organic material and silicon nitride, i.e., a lower film and an upper film.

The passivation layer 180 has a plurality of auxiliary holes 181 having a predetermined depth for contact with the leads (not shown) of the gate driving ICs 400, and a plurality of contact holes 182, 185, and 187 exposing end portions 179 of the data lines 171, the drain electrodes 175, and the storage conductors 177, respectively. The passivation layer 180 and the gate insulating layer 140 have a plurality of contact holes 183 exposing end portions 129 of the gate lines 121. In this case, although the depth of the auxiliary holes 181 exposes the gate insulating layer 140 in FIG. 5, a depth which can accommodate the leads of the gate driving IC 400 is enough.

A plurality of pixel electrodes 190, a plurality of contact assistants 82, and connections 81, which are preferably made of IZO, are formed on the passivation layer 180.

The pixel electrodes 190 are physically and electrically connected to the drain electrodes 175 through the contact holes 185 and to the storage capacitor conductors 177 through the contact holes 187 such that the pixel electrodes 190 receive the data voltages from the drain electrodes 175 and transmit the received data voltages to the storage capacitor conductors 177.

Referring back to FIG. 2, the pixel electrodes 190 supplied with the data voltages generate electric fields in cooperation with the common electrode 270 on the other panel 200, which reorient liquid crystal molecules in the liquid crystal layer 3 disposed therebetween.

As described above, a pixel electrode 190 and a common electrode 270 form a liquid crystal capacitor C_{LC}, which stores applied voltages after turn-off of the TFT Q. An additional capacitor called a “storage capacitor,” which is connected in parallel to the liquid crystal capacitor C_{LC}, is provided for enhancing the voltage storing capacity. The storage capacitors are implemented by overlapping the pixel electrodes 190 with the gate lines 121 adjacent thereto (called “previous gate lines”). The capacitances of the storage capacitors, i.e., the storage capacitances are increased by providing the expansions 127 at the gate lines 121 for increasing overlapping areas and by providing the storage capacitor conductors 177, which are connected to the pixel electrodes 190 and overlap the expansions 127, under the pixel electrodes 190 for decreasing the distance between the terminals.

The pixel electrodes 190 overlap the gate lines 121 and the data lines 171 to increase the aperture ratio, but this is optional.

The contact assistants 82 are connected to the end portions 179 of the data lines 171 through the contact holes 182. The contact assistants 82 are not requisites but are preferred to protect the end portions 179 and to complement the adhesiveness of the end portions 179 and external devices.

The connections 81 are connected to the end portions 129 of the gate lines 121 through the contact holes 183. The connections 81 are also formed on the auxiliary holes 181 and peripheries thereof, and transmit the gate signals from the gate driving ICs 400 to the gate lines 121 via the contact holes 183.

According to another embodiment of the present invention, the pixel electrodes 190 are made of a transparent conductive polymer. For a reflective LCD, the pixel electrodes 190 are made of an opaque reflective metal. In these cases, the connections 81 and the contact assistants 82 may be made of a material such as IZO different from the pixel electrodes 190.

While the present invention has been described in detail with reference to the preferred embodiments, it is to be understood that the invention is not limited to the disclosed embodiments, but, on the contrary, is intended to cover various modifications and equivalent arrangements included within the sprit and scope of the claimed invention.

What is claimed is:

1. A liquid crystal display comprising:
a thin film transistor array panel provided with a display area and a peripheral area, wherein the thin film transistor array panel comprises:
a substrate;
conductive wires formed on the display area and the peripheral area;
shield members positioned on the peripheral area, the shield members being insulated from the conductive wires, and the shield members being formed on the same layer as the conductive wires;
an insulating layer formed on the conductive wires and the shield members, said insulating layer having contact holes exposing a portion of the conductive wires in the peripheral area; and
contact pads formed on the insulating layer that overlap at least a portion of the shield members, said contact pads being electrically connected to the conductive wires in the peripheral area via the contact holes of the insulating layer; and
a light source disposed at the backside of the thin film transistor array panel to provide light thereto, wherein the light source overlaps at least a portion of the shield members.

2. The liquid crystal display of claim 1, further comprising a driving circuit electrically connected to the contact pads of the thin film transistor array panel.

3. The liquid crystal display of claim 1, wherein the conductive wires comprise gate lines transmitting gate signals.

4. The liquid crystal display of claim 1, wherein the conductive wires comprise data lines transmitting data voltages.

5. The liquid crystal display of claim 2, wherein the contact pads comprise depressions for accommodating the driving circuit.

6. The liquid crystal display of claim 1, wherein the contact pads are transparent electrodes.

7. A thin film transistor array panel comprising:
a substrate including a display area and a peripheral area, said peripheral area disposed at the outside of the display area;
shield members formed in the peripheral area;
conductive wires formed on the substrate in the display area and the peripheral area; and
a first insulating layer formed on the shield members and the conductive wires.

8. The thin film transistor array panel of claim 7, further comprising:
contact holes in the first insulating layer exposing a portion of the conductive wires in the peripheral area;
contact pads formed on the first insulating layer that overlap at least a portion of the shield members, said contact pads being electrically connected to the conductive wires in the peripheral area via the contact holes in the first insulating layer.

9. A liquid crystal display comprising:
the thin film transistor array panel of claim 8;
driving signals electrically connected to the contact pads on the shield member; and
a light source disposed at the backside of the thin film transistor array panel to provide light thereto, wherein the light source overlaps at least a portion of the shield members.

10. The thin film transistor array panel of claim 7, wherein the conductive wires comprise gate lines.

11. The thin film transistor array panel of claim 10, further comprising:
semiconductor layers formed on the first insulating layer;
data lines formed on the semiconductor layers; and
drain electrodes separated from the data lines.

12. The thin film transistor array panel of claim 11, further comprising:
a second insulating layer formed on the data lines and the drain electrodes; and
pixel electrodes formed on the second insulating layer and connected to the drain electrodes.

13. The thin film transistor array panel of claim 12, wherein the second insulating layer has auxiliary holes for contact with external devices, and the first and the second insulating layers have contact holes exposing the gate lines.

14. The thin film transistor array panel of claim 13, further comprising connections formed on the auxiliary holes and the peripheries thereof, and connected to the gate lines via the contact holes.

15. The thin film transistor array panel of claim 11, wherein the shield members are electrically connected to a ground voltage.

16. The thin film transistor array panel of claim 7, wherein the shield members are electrically connected to a constant voltage.

17. The thin film transistor array panel of claim 7, wherein the shield members are electrically connected to a voltage supplied by a circuit.

18. The thin film transistor array panel of claim 17, wherein the circuit comprises a flexible printed circuit.

19. A liquid crystal display comprising:
a thin film transistor array panel including a display area provided with a plurality of pixels and display signal lines, and a peripheral area, wherein:
the display signal lines comprise first signal lines; and
shield members are formed on the same layer as the first signal lines in the peripheral area; and
a light source unit disposed at least partly under the peripheral area of the thin film transistor array panel.

20. The liquid crystal display of claim 19, wherein the thin film transistor array panel further comprises:
a first insulating layer formed on the first signal lines and the shield members; and
semiconductor layers formed on the first insulating layer.

21. The liquid crystal display of claim 20, wherein the display signal lines further comprise second signal lines, and the liquid crystal display further comprises output electrodes separated from the second signal lines.

22. The liquid crystal display of claim 21, further comprising a second insulating layer formed on the second signal lines and the output electrodes, and pixel electrodes formed on the second insulating layer and connected to the output electrodes.

23. The liquid crystal display of claim 22, wherein the second insulating layer has auxiliary holes for contact with external devices, and the first and second insulating layers have contact holes exposing the first signal lines.

24. The liquid crystal display of claim 23, further comprising connections formed on the auxiliary holes and peripheries thereof, and connected to the first signal lines via the contact holes.

25. The liquid crystal display of claim 24, wherein the first signal lines are gate lines transmitting gate signals.

26. The liquid crystal display of claim 24, wherein the second signal lines are data lines transmitting data lines.

27. The liquid crystal display of claim 19, wherein the shield members are electrically connected to a ground voltage.

28. The liquid crystal display of claim 19, wherein the light source unit comprises a cold cathode fluorescent lamp.

29. The liquid crystal display of claim 21, further comprising a plurality of gate driving integrated circuits and data driving integrated circuits applying gate signals and data voltages to the first and the second signal lines, respectively, wherein the gate and the data driving integrated circuits are mounted on the shield members.

30. The liquid crystal display of claim 29, wherein the gate and the data driving integrated circuits are mounted as a COG (chip on glass) type in the peripheral area.

31. The liquid crystal display of claim 19, wherein the shield members are electrically connected to a constant voltage.

32. The liquid crystal display of claim 19, wherein the shield members are electrically connected to a voltage supplied by a circuit.

33. The liquid crystal display of claim 32, wherein the circuit is a flexible printed circuit.
